(19) United States
(12) Patent Application Publication
(10) Pub. No.: US 2005/0067897 A1
(43) Pub. Date: Mar. 31, 2005

(54) Vehicle track chain and link therefor

(76) Inventor: Rohan James, Moorabin (AU)

Correspondence Address: Hovey Williams LLP, Suite 400, 2405 Grand Blvd., Kansas City, MO, 64108, US

(21) Appl. No.: 10/990,268

(22) Filed: Nov. 16, 2004

Related U.S. Application Data
(63) Continuation of application No. PCT/AU03/00597, filed on May 19, 2003.

(30) Foreign Application Priority Data
May 17, 2002 (AU) PS2380

(51) Int. Cl. B65G 15/60

(52) U.S. Cl. 305/193

(57) ABSTRACT

A chain link (1) for a track chain of a chain traction vehicle includes a link body (2) having opposite sides (3). Two link pins (14) extending from each side (3) of the link body (2) in spaced relation in a direction of intended travel of the track chain. Connectors (18) are connected to and extending from at least one of the link pins (14). Each connector (18) is also connectable to a juxtaposed pin of an adjacent link (1) so as to interconnect the links (1) into a chain formation. An opening (20) is located outwardly of each side (3) of the link body (2) and between the pins (14) for receiving teeth of sprocket wheels on which the chain is mounted for driving travel of the chain. Fasteners (23) connect with the pins (14) in order to secure the connectors (18) to the pins (14) and interconnect adjacent links into the chain formation. An endless track chain formed of links (1), and connectors (18) for the links (1) are also disclosed.

### RELATED APPLICATION

This application is a continuation of International Application Serial No. PCT/AU03/00597 filed 19 May 2003, published under PCT Article 21(2) in English, and claiming priority from Australian patent application PS 2380 filed 17 May 2002, and applicant claims the benefit of Australian patent application PS 2380 filed 17 May 2002.

### BACKGROUND OF THE INVENTION

1. Field of the Invention

This invention relates to a track chain for chain traction vehicles, as well as a link of the chain. The invention is applicable to armoured vehicles having endless chain traction systems intended both for on and off road travel, and it will be convenient to hereinafter disclose the invention in relation to that exemplary application. It should be appreciated, however, that the invention is not limited to that application.

2. Description of the Prior Art

A track chain for a chain traction vehicle is disclosed in Australian patent 585458. That track chain has chain links, each of which has at least two openings to receive the teeth of driving sprocket wheels of a traction system in order to drive the chain in a circular direction. Each of the openings is bordered by portions of two tubular members, extending at right angles to the direction of travel of the chain, and also two lateral webs. The flanks of the sprocket wheel teeth engage cam surfaces on the tubular members during the driving action.

In this track chain, pins extend through and protrude from each of the tubular members. Connectors are arranged on the pins so as to connect together juxtaposed pins of adjacent links, and so interconnect the links into an endless chain. The connectors are disposed laterally outwardly of the openings.

Each connector is clamped to its respective pins so as to be secured against relative rotation. The necessary clamping forces on the connectors are produced by screws fitted to the connectors.

This chain and chain link have a number of disadvantages. Specifically, the connectors are prone to disengage from their pins thereby causing the chain to break. That disengagement has occurred because of the ineffectiveness of the connection between the connectors and pins. In particular, the clamping forces provided by the screws between the connectors and pins have been insufficient to maintain the interconnection under influence of the substantial lead forces applied to the links during chain travel. Depending on the speed at which the vehicle is travelling when chain breakage occurs, the resulting differential driving forces then applied to the traction chains can force the vehicle to overturn, leading to potentially dangerous consequences.

The pins are subject to substantial driving and other forces transmitted through the links and connectors. In particular, because the connectors are located at the ends of the pins, those forces can result in excessive deflections of the pins, leading to pin failure.

The cam surfaces of the tubular members tend to wear due to the repeated sliding engagement with the sprocket wheel teeth. The wear rate is increased by the grinding action of dirt and grit deposited on the teeth and chain links during travel, particularly off road travel, of the vehicle.

The cam surface wear rate can be reduced through hardening of those surfaces, although even then they eventually become unserviceable. When that occurs it is usually uneconomic to refurbish the cam surfaces. Since those surfaces are provided on the tubular members forming an integral part of the link, it is necessary to discard the link for a new replacement link, which is costly.

The particular design of the previous link, including the configuration of the openings and cam surfaces, results in the link being expensive to manufacture.

### SUMMARY OF THE INVENTION

It is an object of the present invention to provide an improved track chain for chain traction vehicles.

It is another object of the present invention to provide an improved link for a track chain for chain traction vehicles.

With those objects in mind, the present invention in one aspect provides a chain link for a track chain of a chain traction vehicle, the chain link including:
a link body having opposite sides;
two link pins extending from each side of the link body in spaced apart relation in a direction of intended travel of the track chain;
connectors connected to and extending from at least one of the link pins, each connector being connectable to a juxtaposed pin of an adjacent link so as to interconnect the links in a chain formation; and
an opening located outwardly of each side of the link body and between the pins for receiving teeth of sprocket wheels on which the chain is mounted for driving travel of the chain.

In another aspect, the present invention provides a chain link for a track chain of a chain traction vehicle, the chain link including:
a link body having opposite sides;
two link pins extending from each side of the link body in spaced apart relation in a direction of intended travel of the track chain;
connectors connected to an extending from at least one of the link pins, each connector being connectable to a juxtaposed pin of an adjacent link so as to interconnect the links in a chain formation; and
an opening located adjacent each side of the link body and at least partially defined by the connectors, each opening receiving teeth of sprocket wheels on which the chain is mounted for driving travel of the chain, the sprocket wheel teeth engaging with the connectors for driving travel of the chain.

In a further aspect, the present invention provides a chain link for a track chain of a chain traction vehicle, the chain link including:
a link body having opposite sides;
two link pins extending from each side of the link body in spaced apart relation in a direction of intended travel of the track chain;
connectors connected to an extending from at least one of the link pins, each connector being connectable to a juxtaposed pin of an adjacent link so as to interconnect the links in a chain formation;
at least one opening for receiving teeth of sprocket wheels on which the chain is mounted for driving travel of the chain; and
fasteners on the pins for securing the connectors to the pins and thereby interconnecting adjacent links to form the chain formation.

In yet another aspect, the invention provides a track chain including a plurality of the above links interconnected in seriatim with the connectors.

In a still further aspect, the present invention provides a connector for the above link.

Preferably, the connectors have cam surfaces upon which the sprocket wheel teeth engage for driving travel of the chain. Preferably, each connector has opposite end regions, and each end region has one of the cam surfaces. Thus, the cam surface at one end region is associated with the chain link, and the cam surface at the other end region is associated with an adjacent chain link. In one preferred arrangement, each cam surface faces across a respective opening toward a cam surface of an adjacent connector.

Preferably, each connector is connected to respective pins at the end regions thereof. Moreover, preferably each cam surface is convexly curved about a longitudinal axis of the pin to which the respective end region of the connector is connected. Each cam surface preferably lies in an arcuate plane extending parallel to the longitudinal axis of the respective pin.

Preferably, each connector has spaced apart end regions with holes for receiving respective link pins there through to connect the connector to the pins. In one preferred arrangement, the link pins and connector holes are configured so as to prevent relative rotation between the connectors and link pins about the longitudinal axes of the link pins.

Preferably, the fasteners interconnect with the pins so that the connectors are captured between the link body and fasteners.

Preferably, a separate fastener is provided for each pin and associated connector. Those fasteners preferably removably interconnect with the pins so as to enable removal of the connectors from the pins.

Preferably, the fasteners interconnect with the link pins through screw thread connections. In one preferred arrangement, each fastener includes a screw threaded nut, and each link pin has a screw threaded end region for receiving a respective nut thereon.

Preferably, the chain link includes further connectors extending between the link pins outwardly of each sprocket wheel teeth opening and further defining the openings. Two further connectors are preferably provided, each connector being located on a respective side of the link body and extending between and being connected to the two link pins.

Preferably, each further connector has a connector body having holes for receiving respective link pins therethrough to connect the connectors to the pins.

Preferably, the fasteners secure the further connectors on the link pins. Moreover, in one preferred arrangement the holes in the further connector bodies are counter bored so as to house the fasteners securing the connectors on the pins.

In one preferred arrangement, the link body is of one piece integral construction. However, in an alternative arrangement the link body has at least two separate pieces assembled side-by-side on the link pins.

Preferably, the link body has holes in which the link pins are received and supported for relative rotation between the link body and link pins about the longitudinal axes of the link pins.

### DESCRIPTION OF THE DRAWINGS

The following description refers to preferred embodiments of the track chain and chain link of the present invention. To facilitate an understanding of the invention, reference is made in the description to the accompanying drawings where the track chain and chain link are illustrated in those preferred embodiments. It is to be understood that the track chain and chain link are not limited to the preferred embodiments as hereinafter described and as illustrated in the drawings.

In the drawings, where the same reference numerals identify the same or like components:

FIG. 1 is a perspective view from an outer side of a chain link, with additional connectors, according to one preferred embodiment of the present invention;

FIG. 2 is a perspective view from an inner side of the chain link with additional connectors of FIG. 1;

FIG. 3 is a perspective view similar to FIG. 1 but with the chain link and connectors shown exploded;

FIG. 4 is a view similar to FIG. 3, from a different perspective;

FIG. 5 is a perspective view from an outer side of a chain link according to another preferred embodiment of the present invention;

FIG. 6 is a perspective view similar to FIG. 5 but with the chain link shown exploded; and,

FIG. 7 is a perspective view of part of a track chain formed of links shown in FIGS. 5 and 6.

### DETAILED DESCRIPTION OF PREFERRED EMBODIMENTS OF THE INVENTION

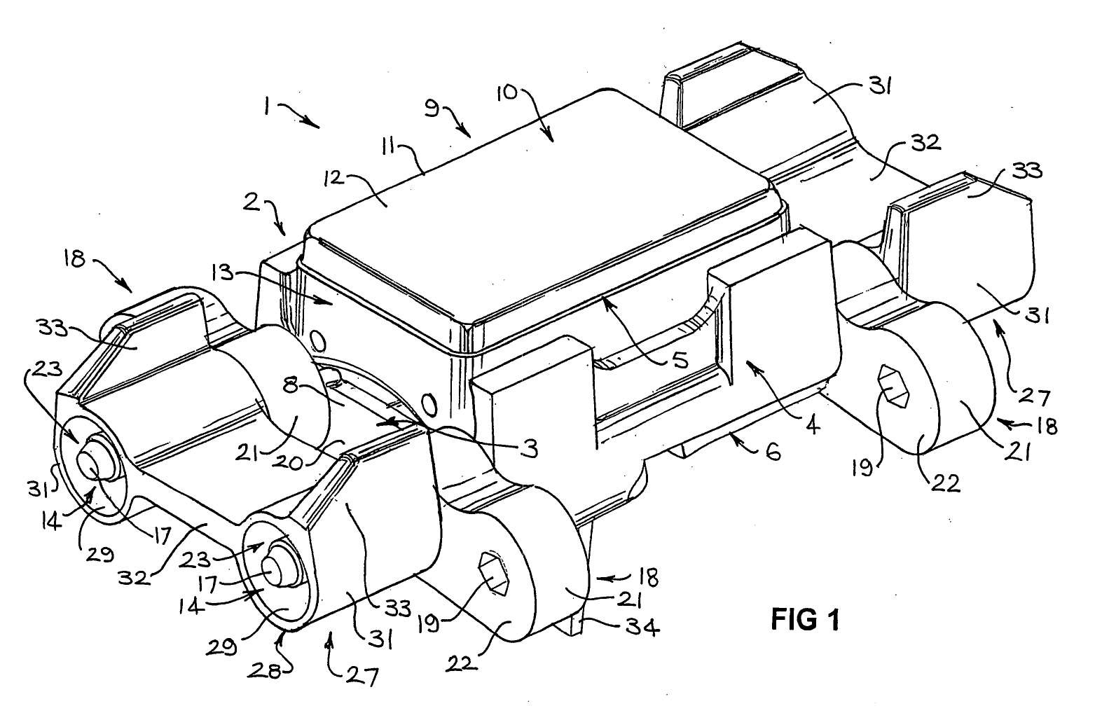

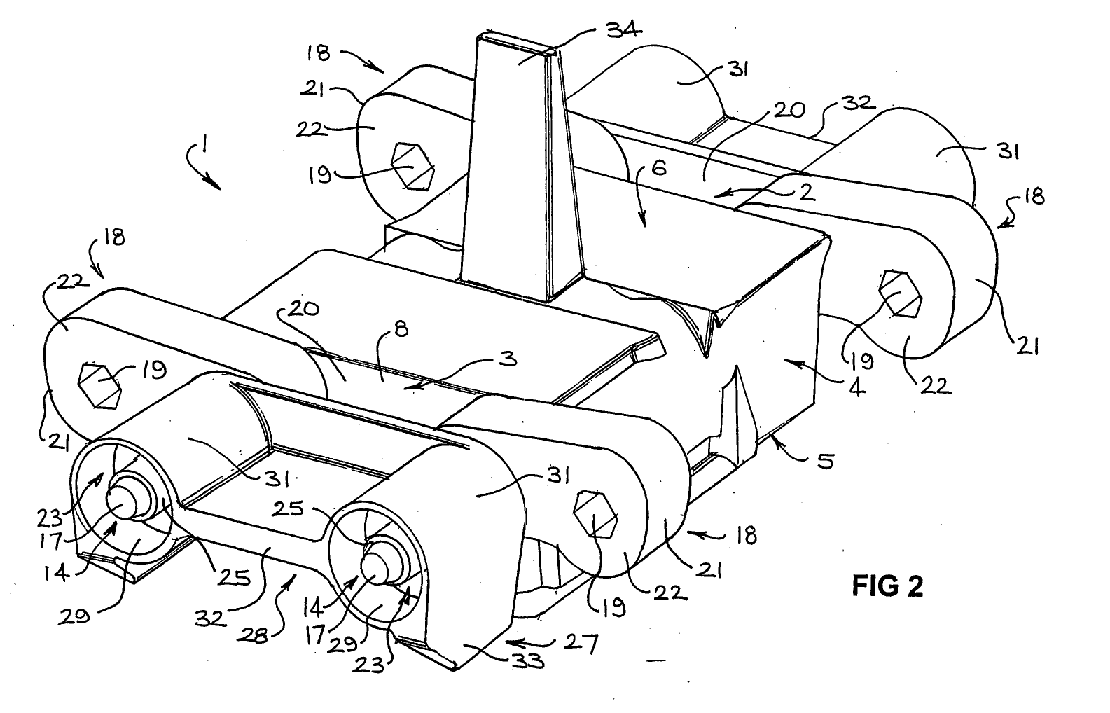

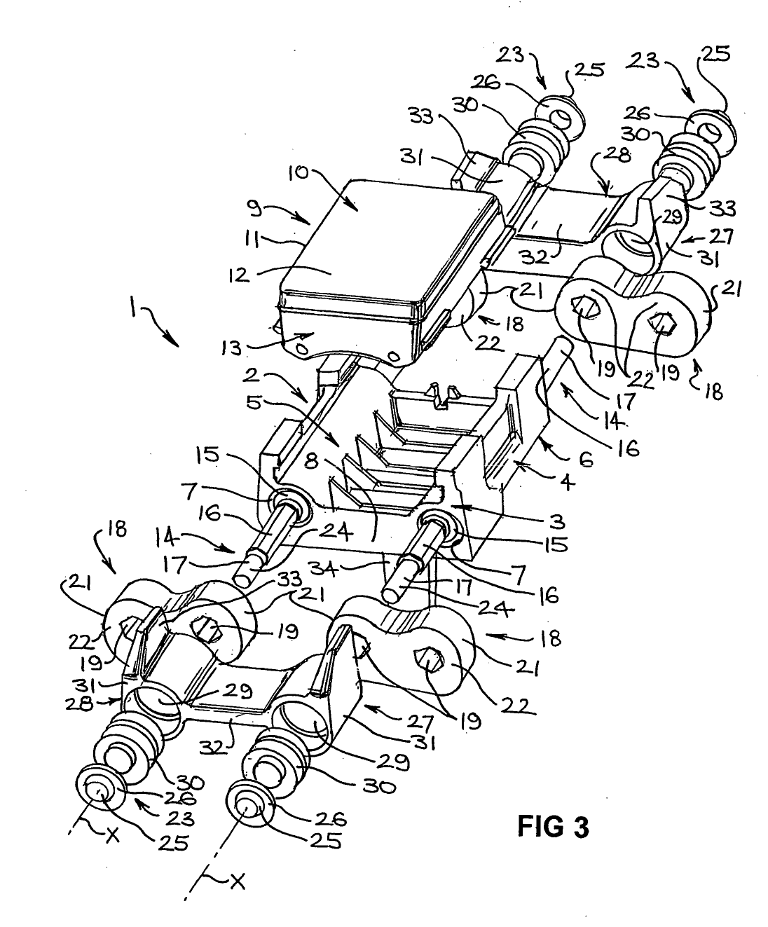

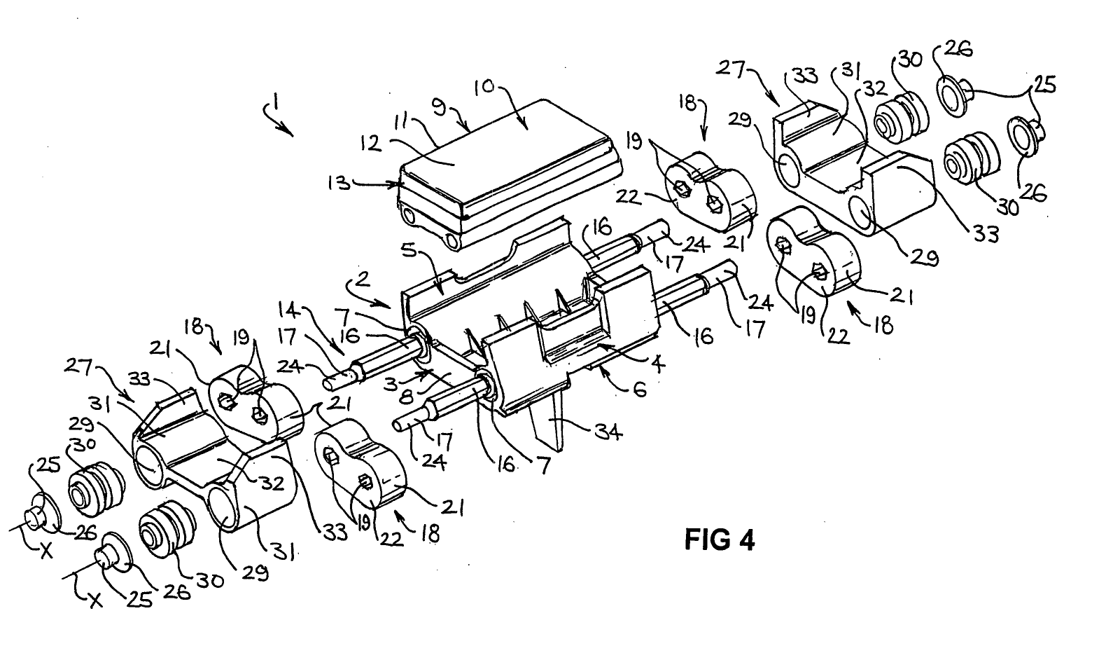

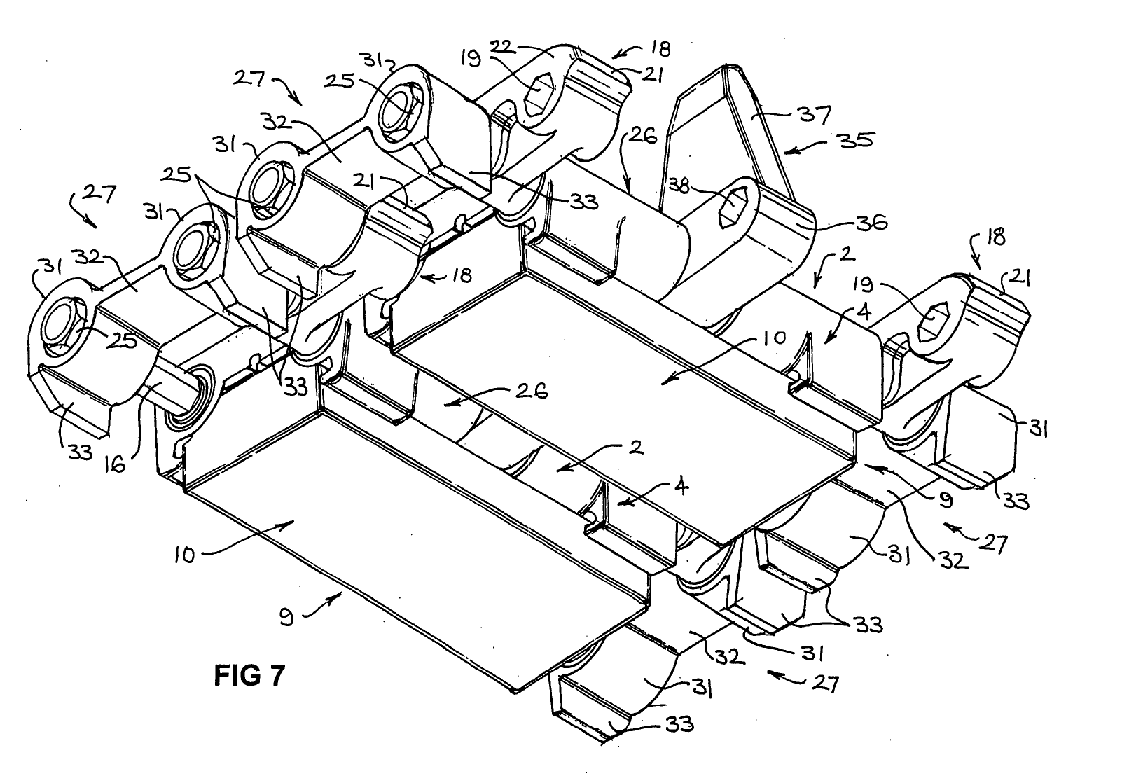

Referring to FIGS. 1 to 4 of the drawings there is generally shown a chain link 1 for a track chain of a chain traction vehicle (not shown). As will become more apparent hereinafter, with reference to FIG. 7, a plurality of the chain links 1 can be interconnected in seriatim to form an endless track chain 39.

The chain link 1 includes a link body 2 having a pair of opposite sides 3 and a pair of ends 4 extending between the sides 3. In use, the link 1 is arranged end-to-end with other links 1 in order to form the chain 39, the body sides 3 extending in a longitudinal direction of the chain 39.

The link body 2 is of a one piece, integral construction in this embodiment. That body 2 may be cast from metal, such as steel.

The body 2 also has an outer face 5 and an inner face 6 relative to the orientation of the link 1 when in use in a track chain 39. Thus, the outer face 5 is directed outwardly toward ground or another surface over which the chain 39 travels during vehicle movement, whilst the inner face 6 is directed inwardly towards sprocket wheels (not shown) over which the chain 39 travels during chain driving.

The link body 2 has holes 7 opening through the body sides 3. The holes 7 are elongate, and extend parallel to one another and perpendicular to the direction of travel of the chain link 1. The body sides 3 have faces 8 onto which the holes 7 open. As shown, a pair of holes 7 are provided, each hole 7 extending through the body 2 and opening at respective ends onto the body side faces 8. The holes 7 are located adjacent respectively ends 4 of the body 2.

The link 1 includes a tread member 9 on the body 2 for engaging with the ground or other surface over which the chain 39 travels. That tread member 9 is mounted on the body outer face 5.

In this embodiment, the tread member 9 includes a tread pad 10. The tread pad 10 is removably mounted on the body outer face 5 so that the pad 10 can be readily replaced when worn. The tread pad 10 has a rubber pad 11 providing a ground engaging surface 12, and a mounting base 13 supporting the rubber pad 11 and through which the tread pad 10 is mounted on the link body. That mounting may be by way of any suitable fasteners and/or clips.

Two link pins 14 extend along respective holes 7 and protrude from each side 3 of the body 2.

The pins 14 are supported in their respective holes 7 for rotation about their longitudinal axes X relative to the link body 2. To that end, the link 1 has bearing members 15 fitted into the body holes 7 and in which the pins 14 are journalled. The bearing members 15 are located at least adjacent the hole openings in the body side faces 8 so as to support the pins 14 against deflection relative to the body 2 during link use. Those bearing members 15 may be bearing bushes, such as rubber bushes.

The pins 14 have connection regions 16 extending from the link body 2. Those connection regions 16 are spaced inwardly from end regions 17 of the pins 14. Moreover, the regions 16 are immediately adjacent the body sides 3 from which the pins 14 protrude.

Connectors 18 are provided for interconnecting adjacent links 1 one to another. Each link 1 usually has two connectors 18, typically associated with one link pin 14. As shown in this embodiment, two additional connectors 18 are provided in association with the other pin 14. Those additional connectors 18 may form part of an adjacent link (not shown) or may be included in the link 1 particularly for link replacement within a chain.

Each connector 18 extends from a connection region 16 of a respective pin 14 to a connection region 16 of a juxtaposed pin 14 of an adjacent link. The connectors 18 have holes 19 therethrough into which the pin connection regions 16 are received. Thus, the pins 14 extend through respective holes 19 of the connectors 18, with the connectors 18 being located longitudinally along the pins 14 at the connection regions 16.

The connection regions 16 and connector holes 19 are configured to complement one another. In particular, the regions 16 are shaped and sized so that the connectors 18 are non-rotatable about the longitudinal axes X of the pins 14. Thus, in use of the link 1, the connectors 18 and pins 14 rotate together in the bearing members 15 relative to the link body 2 in order to articulate the chain 39. The connectors 18 can be slidable along the pins 14.

The connection regions 16 and connector holes 19 have non-circular cross-sectional shapes, in this embodiment. That shape may be hexagonal or octagonal, although other multi-sided shapes may also be suitable.

The spacing between the pins 14 and connectors 18 on each side 3 of the link body 2 provides a respective opening 20 outwardly of each link body side 3. In link use, the teeth of sprocket wheels on which the chain 39 is mounted are received in the openings 20 to cause driving travel of the chain 39. During receipt of the sprocket wheel teeth in the openings 20, teeth drivingly engage with the connectors 18. To that end, the connectors 18 provide cam surfaces 21 upon which the teeth engage.

Each connector 18 has opposite end regions 22 providing the cam surfaces 21. Thus, one end region 22 provides a cam surface 21 associated with one chain link 1, and the other end region 22 provides a cam surface 21 associated with an adjacent link 1 to which the one link 1 is connected. Each cam surface 21 faces across an opening 20 between the two pins 14 toward another cam surface 21 of an adjacent connector 18.

Each cam surface 21 is convexly curved about the longitudinal axis X of the pin 14 on which the respective end region 22 of the connector 18 is mounted. Thus, the surface 21 lies in an arcuate plane extending parallel to the longitudinal axis X.

The link 1 includes fasteners 23 on the pins 14 for securing the connectors 18 on the pins 14 and thereby interconnecting adjacent links 1.

The fasteners 23 interconnect with the pins 14 at their end regions 17. The configuration is such that the connectors 18 are captured between the body 2 and fasteners 23.

A separate fastener 23 is associated with each pin end region 17. Moreover, each fastener 23 removably interconnects with its respective pin 14 so as to enable dismantling of the link 1 and chain for servicing. In particular, the connectors 18 are removable for replacement when their cam surfaces 21 become worn.

The fasteners 23 and pins 14 are interconnectable through a screw thread connection 24. Thus, the fasteners 23 and pin end regions 17 each have co-operable screw thread forms.

Each fastener 23 includes a screw threaded nut 25 for interengaging with a respective screw threaded pin end region 17. Each fastener 23 may also include a washer 26 for interposing between the nut 25 and respective connector 18.

The chain link 1 includes further connectors 27 extending between the link pins 14 and, with the connector end regions 22, defining the openings 20 for the sprocket wheel teeth. Thus, further connectors 27 extend between the two pins 14 on the opposite sides of the connectors 18 to the body 2. Those further connectors 27 are connected to the pins 14 and act to stabilise the pins 14 against deflection during link use. Those further connectors 27 also assist in retaining the connectors 18 in position on the pins 14. In the particular application of the chain link, those further connectors 27 can function as grousers.

The grouser connectors 27 each have a body 28 with spaced apart holes 29 for receiving the pins 14 therethrough to connect the connectors 27 to the pins 14. The holes 29 extend through the grouser connector bodies 28, and receive the pin end regions 17 for interconnecting with the fastener nuts 25. In this way, the fastener nuts 25 also act to retain the grouser connectors on the pins 14.

The holes 29 in the grouser connector bodies 28 can be counter bored so as to house and to protect the fastener nuts 25 from damage during link use.

The pins 14 are received in the holes 29 for rotation about their longitudinal axes X. To that end, the grouser connectors 27 include bearing members 30 fitted into the holes 29 and in which the pins 14 are journalled. Those bearing members 30 may be bearing bushes, such as rubber bushes. In this form, the fastener washers 26 act as safety retainers against movement or migration of the grouser connectors 27 on the bearing members 30.

Each grouser connector body 28 is of one piece, rigid construction. The body 28 has a pair of spaced apart boss portions 31 defining the holes 29 and a web portion 32 extending therebetween. At least one grouser tooth 33 extends outwardly from each boss portion 31. The connector bodies 28 may be composed of rubber.

The chain link 1 includes a guide horn 34 for co-operating with a vehicle track chain mounting assembly (not shown) in order to facilitate retention of the chain 39 in position during vehicle use, as will be well known by persons skilled in the relevant art. The guide horn 34 extends inwardly from the link body 2. In this embodiment, the guide horn 34 is formed integral with the link body 2 and outstands from the inner face 6.

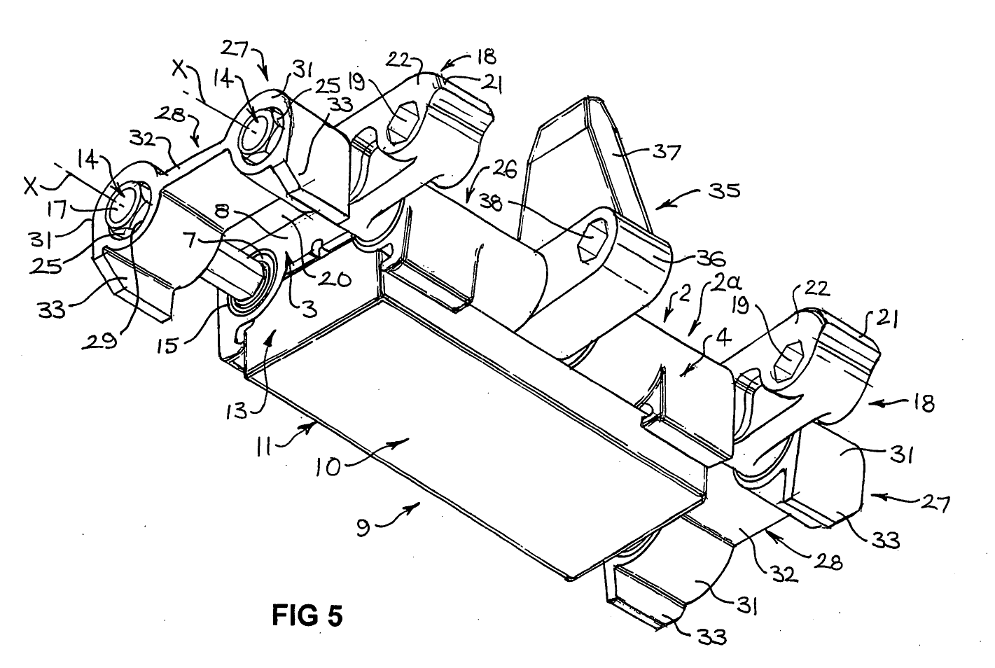

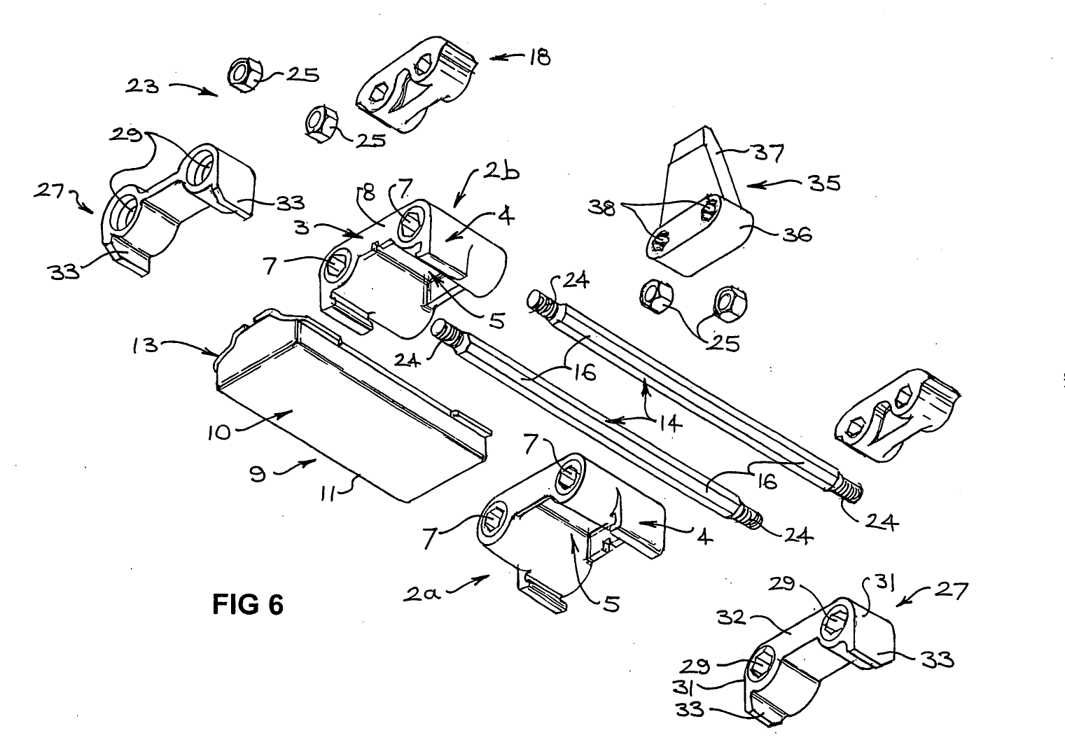

Referring now to drawing FIGS. 5 and 6, a modified chain link 1 is shown. In this embodiment, the link 1 is generally the same as the above described link 1 except that the link body 2 is constructed in separate pieces 2a and 2b assembled side-by-side on the link pins 14.

In addition, rather than providing a guide horn 34 integral with the link body 2, a separate guide horn piece 35 is provided for association with an adjacent pair of links 1. The guide horn piece 35 is located between the body pieces 2a and 2b, and includes a base connector 36 from which an integral guide horn 37 outstands. The base connector 36 has a spaced apart pair of holes 38 extending therethrough and axially aligned with the holes 7 in the body pieces 2a and 2b for receiving one pin 14 of the link 1 and a juxtaposed pin 14 of an adjacent chain link 1. In this way, the base connector 36 of the guide horn piece 35 acts as an additional connector between adjacent links 1. The provision of this additional connector between links 1 acts to better distribute and share the load applied to the links 1 and chain 39 during use.

The holes 38 in the base connector 36 are of the same shape and size as the connector holes 19 so that the guide horn piece 35 is non-rotatable about the longitudinal axes X of the pins 14.

It will be appreciated that variations of this modified link 1 may be made. For example, the link body 2 may be composed of more than two separate pieces arranged side-by-side, and more than one guide horn piece 35 may be provided between those body pieces. Alternatively, the link body 2 may be formed in one piece and provided with cut outs to receive the guide horn pieces 35. Moreover, one or more guide horn pieces 35 may be replaced by a simple connector for interconnecting juxtaposed pins 14 of adjacent links 1. Where all of the guide horn pieces 35 are replaced with simple connectors, then a horn may be formed integral with the link body or one of the link body pieces.

Finally, referring to FIG. 7 there is shown part of an endless track chain 39. The chain 39 is formed of interconnected links 1 of the type shown in FIGS. 5 and 6. For simplicity, two only links 1 are shown in detail. It will be appreciated that links 1 of the type shown in FIGS. 1 to 4 can be similarly interconnected into a chain formation.

The chain link of the present invention provides for the connectors interconnecting adjacent links to be firmly secured to those links. The fasteners used for that securement are less likely to fail compared with previous fastening arrangements, and thereby reduces the prospects of connectors disengagement and chain breakage.

In addition, trapping of the connectors between the link body and grouser connectors tends to improve link safety even in the event of the fastener failure. In that regard, should a fastener fail then the adjacent grouser connector can act to retain the connector in place. The pin with the failed nut has to travel a considerable distance before that connector disengages from the pin, and the resulting delay in that disengagement provides an opportunity for corrective action to be taken.

The configuration of the chain link achieves better distribution of load forces within the chain link during use, and so reduces the prospect of link failure under action of those forces, compared with prior chain links. In particular, the location of the connectors “in line” with the sprocket wheel teeth openings, and the grouser connectors out board of those connectors, reduces potentially damaging pin deflections under the load forces.

The configuration of the connectors so that they are engaged by the sprocket wheel teeth permit economic maintenance and refurbishment of the chain link. In particular, the provision of the cam surfaces engaged by the teeth, and removable mounting of the connectors on the pins, enable the connectors to be readily removed and replaced when worn.

The components of the chain link are relatively cheap to manufacture, so that link costs are reasonable.

Finally, it is to be understood that various alterations, modifications and/or additions may be made to the chain link and chain without departing from the ambit of the present invention as defined in the claims appended hereto.

1. A chain link for a track chain of a chain traction vehicle, the chain link including:
a link body having opposite sides;
two link pins extending from each side of the link body in spaced apart relation in a direction of intended travel of the track chain;
connectors connected to and extending from at least one of the link pins, each connector being connectable to a juxtaposed pin of an adjacent link so as to interconnect the links into a chain formation; and
an opening located outwardly of each side of the link body and between the pins for receiving teeth of sprocket wheels on which the chain is mounted for driving travel of the chain.

2. A chain link as claimed in claim 1, wherein the openings are at least partially defined by the connectors, and the sprocket wheel teeth engage with the connectors for driving travel of the chain.

3. A chain link as claimed in claim 2, wherein the connectors at least partially defining the openings have cam surfaces upon which the sprocket wheel teeth engage for driving travel of the chain.

4. A chain link as claimed in claim 3, wherein each connector at least partially defining the openings has opposite end regions, and each end region has one of the cam surfaces, the cam surface at one end region being associated with the chain link and the cam surface at the other end region being associated with an adjacent chain link.

5. A chain link as claimed in claim 3 or 4, wherein each cam surface faces across a respective opening toward a cam surface of an adjacent connector.

6. A chain link as claimed in any one of claims 3 to 5, wherein each connector is connected to respective pins at the end regions thereof, and each cam surface is convexly curved about a longitudinal axis of the pin to which the respective end region of the connector is connected.

7. A chain link as claimed in claim 6 wherein each cam surface lies in an arcuate plane extending parallel to the longitudinal axis of the respective pin.

8. A chain link as claimed in any preceding claim, wherein each connector has spaced apart end regions with holes for receiving link pins there through to connect the connector to the pins.

9. A chain link as claimed in claim 8, wherein the link pins and connector holes are configured so as to prevent relative rotation between the connectors and link pins about the longitudinal axes of the link pins.

10. A chain link as claimed in any preceding claim, and including fasteners on the pins for securing the connectors on the pins and thereby interconnecting adjacent chain links.

11. A chain link as claimed in claim 10, wherein the fasteners interconnect with the pins so that the connectors are captured between the link body and fasteners.

12. A chain link as claimed in claim 11, wherein a separate fastener is provided for each pin and associated connector.

13. A chain link as claimed in any one of claims 10 to 12, wherein the fasteners removably interconnect with the pins so as to enable removal of the connectors from the pins.

14. A chain link as claimed in any one of claims 10 to 13, wherein the fasteners interconnect with the link pins through screw thread connections.

15. A chain link as claimed in claim 14, wherein each fastener includes a screw threaded nut, and each link pin has a screw threaded end region for receiving a respective nut thereon.

16. A chain link as claimed in any preceding claim, and including further connectors extending between the link pins outwardly of each sprocket wheel teeth opening and further defining the openings.

17. A chain link as claimed in claim 16, wherein two further connectors are provided, each further connector being located on a respective side of the link body, and extending between and being connected to the two link pins.

18. A chain link as claimed in claim 16 or 17, wherein each further connector has a connector body having holes for receiving respective link pins there through to connect the connectors to the pins.

19. A chain link as claimed any one of claims 16 to 18 when appended to any one of claims 10 to 15, wherein the fasteners secure the further connectors on the link pins.

20. A chain link as claimed in claim 19 when appended to claim 18, wherein the holes in the spaced apart end regions of the further connectors are counter bored so as to house the fasteners securing the connectors on the pins.

21. A chain link as claimed in any one of claims 16 to 20, wherein the further connectors function as grousers.

22. A chain link as claimed any preceding claim, wherein the link body is of one piece integral construction.

23. A chain link as claimed in any one of claims 1 to 21, wherein the link body has at least two separate pieces assembled side-by-side on the link pins.

24. A chain link as claimed in any preceding claim, wherein the link body has holes in which the link pins are received and supported for relative rotation between the link body and link pins about the longitudinal axes of the link pins.

25. A chain link for a track chain of a chain traction vehicle, the chain link including:
a link body having opposite sides;
two link pins extending from each side of the link body in spaced apart relation in a direction of intended travel of the track chain;
connectors connected to and extending from at least one of the link pins, each connector being connectable to a juxtaposed pin of an adjacent link so as to interconnect the links into a chain formation; and,
an opening located adjacent each side of the link body and at least partially defined by the connectors, each opening receiving teeth of sprocket wheels on which the chain is mounted for driving travel of the chain, the sprocket wheel teeth engaqing with the connectors for driving travel of the chain.

26. A chain link for a track chain of a chain traction vehicle, the chain link including:
a link body having opposite sides;
two link pins extending from each side of the link body in spaced apart relation in a direction of intended travel of the track chain;
connectors connected to and extending from at least one of the link pins, each connector being connectable to a juxtaposed pin of an adjacent link so as to interconnect the links into a chain formation;
at least one opening for receiving teeth of sprocket wheels on which the chain is mounted for driving travel of the chain; and,
fasteners on the pins for securing the connectors to the pins and thereby interconnecting adjacent links into the chain formation.

27. A chain link for a track chain of a chain traction vehicle, substantially as hereinbefore described with reference to any one of the embodiments shown in the accompanying drawings.

28. A track chain for a chain traction vehicle, including a plurality of chain links interconnected in seriatim, each chain link as claimed in any preceding claim.

29. A connector for a chain link as claimed in any one of claims 1 to 27.
